(19) United States
(12) Patent Application Publication
(10) Pub. No.: US 2012/0133626 A1
(43) Pub. Date: May 31, 2012

(54) Scan driver and method of driving the same

(76) Inventors: Kyung-Hoon Chung, Yongin-city (KR); Seong-Il Park, Yongin-city (KR); Dong-Wook Park, Yongin-city (KR)

(21) Appl. No.: 13/137,974

(22) Filed: Sep. 22, 2011

(30) Foreign Application Priority Data
Nov. 29, 2010 (KR) 10-2010-0119885

(51) Int. Cl. G06F 3/038

(52) U.S. Cl. 345/208

(57) ABSTRACT

A scan driver of a display device may include a plurality of scan lines. The scan driver may include a plurality of stages configured to transmit scan signals to the scan lines. Each stage may include an input terminal for receiving a scan signal from a previous stage, an output terminal, an output unit, a sequential switching unit, and a simultaneous switching unit. The output unit may be coupled to the output terminal, and outputs a corresponding scan signal to the output terminal. The sequential switching unit may be coupled to the input terminal, and controls the output unit such that the output unit of each stage sequentially outputs the scan signals having a first voltage in a first period. The simultaneous switching unit may control the output unit such that the output unit of each stage simultaneously output the scan signals having a predetermined voltage in a second period.

### BACKGROUND

1. Field

Embodiments relate to a scan driver and a method of driving the same.

2. Description of the Related Art

An active matrix display device, i.e., an organic light emitting diode (OLED) display or a liquid crystal display (LCD), includes a plurality of pixels defined by a plurality of scan lines extending to a row direction and a plurality of data lines extending to a column direction. A scan driver sequentially applies a scan pulse to the scan lines, and a data driver applies data to the data lines to store desired data in the pixels. Thus, an image is displayed.

The display devices simultaneously apply a predetermined voltage to the scan lines to simultaneously reset the pixels, allow the pixels to simultaneously emit light, or allow the pixels to stop emitting the light.

The information in the Background is only for enhancing an understanding of the described technology. Thus, it may contain information that does not form the prior art already known to a person of ordinary skill in the art in this country.

### SUMMARY

Embodiments may be directed to a scan driver for simultaneously applying a predetermined voltage.

According to an embodiment, a scan driver of a display device, including a plurality of scan lines, may be provided. The scan driver includes a plurality of stages configured to transmit scan signals to the scan lines. Each stage of the plurality of stages includes an input terminal for receiving a scan signal from a previous stage, an output terminal, an output unit, a sequential switching unit, and a simultaneous switching unit. The output unit is coupled to the output terminal, and outputs a corresponding scan signal of the scan signals to the output terminal. The sequential switching unit is coupled to the input terminal, and controls the output unit such that the output unit of stages sequentially outputs the scan signals having a first voltage in a first period. The simultaneous switching unit controls the output unit such that the output unit of the stages simultaneously outputs the scan signals having a predetermined voltage in a second period.

Each stage of the plurality of stages may receive a control signal having a first level in the first period, and having a second level in the second period.

Each stage of the plurality of stages may receive a first and a second control signal, and the second period may include a third period and a fourth period. The simultaneous switching unit may set the first voltage to the predetermined voltage in response to the first control signal having a first level in the third period, and may set the second voltage to the predetermined voltage in response to the second control signal having the first level in the fourth period.

The second control signal may have a second level in the third period, and the first control signal may have the second level in the fourth period.

The first control signal may be set to the first level after the second control signal is set to the second level in the third period, and the second control signal may be set to the first level after the first control signal is set to the second level in the fourth period.

Each stage may further include a first, a second, and a third clock terminal. A first, a second, and a third clock signal may be alternately applied to the first, the second, and the third clock terminal in the stages. The first, the second, and the third clock signal, each having a cycle of 3 horizontal periods and a duty ratio of 1/3, may sequentially have the first level in the first period.

The sequential switching unit may control the output unit in response to the first, the second, and the third clock signal in the first period, and the output unit may output a voltage of the third clock terminal as the first voltage of the scan signal in the first period. A control of the simultaneous switching unit may be terminated in accordance with the voltage of the third clock terminal in the first period.

The first, the second, and the third clock signal may have a steady level in the second period.

A first, a second, a third, a fourth, a fifth, and a sixth clock signal, each having a cycle of 6 horizontal periods and a duty ratio of 1/3, may be applied to the stages, and may sequentially have the first level in the first period. The first, the third, and the fifth clock signal may be alternately applied to the first, the second, and the third clock terminal of odd numbered stages, among the stages, and the second, the fourth, and the sixth clock signal may be alternately applied to even numbered stages, among the plurality of stages.

The sequential switching unit of each odd numbered stage may control the output unit in response to the first, the third, and the fifth clock signal in the first period. The sequential switching unit of each even numbered stage of the plurality of stages may control the output unit in response to the second, the fourth, and the sixth clock signal in the first period. The output unit may output a voltage of the third clock terminal as the first voltage of the scan signal in the first period. A control of the simultaneous switching unit may be terminated, in accordance with the voltage of the third clock terminal in the first period.

The first, the second, the third, the fourth, the fifth, and the sixth clock signal may have a steady level.

According to another embodiment, each stage of the plurality of stages includes a first voltage terminal for supplying a first voltage, a second voltage terminal for supplying a second voltage, an input terminal for receiving a scan signal from a previous stage, an output terminal, a first clock terminal, first, second and third transistors, a sequential switching unit, and a simultaneous switching unit. The first transistor is coupled between the first voltage terminal and the output terminal, and has a gate coupled to a first junction point. The second transistor is coupled between the output terminal and the first clock terminal, and has a gate coupled to the second junction point. The third transistor is coupled between the output terminal and the second voltage terminal, and has a gate coupled to a third junction point. The sequential switching unit is coupled to the input terminal, the first and the second junction points, and controls the first and the second transistor such that output units of the stages sequentially output the scan signals having the second voltage in a first period. The simultaneous switching unit turns on the first transistor or the third transistor in a second period such that the first transistor of the stages or the second transistor of the stages is simultaneously turned on in a second period.

The second period may include a third period and a fourth period. The simultaneous switching unit may turn on the third transistor in the third period, and may turn on the first transistor in the fourth period.

Each stage of the plurality of stages may receive a first and a second control signal. The simultaneous switching unit may set the third junction point to a gate-on voltage, in response to the first control signal having a first level in the third period, and may set the first junction point to the gate-on voltage, in response to the second control signal having the first level in the fourth period.

The second control signal may have a second level in the third period, and the first control signal may have the second level in the fourth period.

The simultaneous switching unit may includes a fourth transistor coupled between the third junction point and the second voltage terminal, and configured to be turned on in response to the first control having the first level, and a fifth transistor coupled between the first junction point and the second voltage terminal, and configured to be turned on in response to the second control signal having the first level.

The simultaneous switching unit may further include a sixth transistor coupled between the first voltage terminal and the first junction point, and configured to be turned on in response to the first control signal having the first level, and a seventh transistor coupled between the first voltage terminal and the third junction point, and configured to be turned on in response to the second control signal having the first level.

The sequential switching unit may include a sixth transistor coupled between the second junction point and the first voltage terminal, and configured to be turned on in response to the first control signal having the first level.

The sequential switching unit may include a sixth transistor coupled between the first voltage terminal and the second junction point, and having a gate coupled to the first junction point, a seventh transistor coupled between the first junction point and the second voltage terminal, and having a gate coupled to a second clock terminal, and an eighth transistor coupled between the input terminal and the second junction point, and having a gate coupled to a third clock terminal.

The sequential switching unit may further include a ninth transistor coupled between the first voltage terminal and the first junction point, and having a gate coupled to the second junction point.

The sequential switching unit may further include a ninth transistor coupled between the first voltage terminal, and the first junction point and having a gate coupled to the input terminal.

A ratio of a channel width to a channel length in the fifth transistor may be equal to or greater than a ratio of a channel width to a channel length in the ninth transistor.

The sequential switching unit may further include a capacitor coupled between the first voltage terminal and the first junction point.

A first, a second, and a third clock signal may be alternately applied to the first, the second, and the third clock terminal in the stages. The first, the second, and the third clock signals, each having a cycle of 3 horizontal periods and a duty ratio of 1/3, may sequentially have the first level in the first period. The second voltage may correspond to the first level of the first clock terminal, and the first, the second, and the third clock signal may have the second level in the second period.

A first, a second, a third, a fourth, a fifth, and a sixth clock signal may be applied to the stages. The first, the third, and the fifth clock signals may be alternately applied to the first, the second, and the third clock terminals of odd numbered stages among the stages, and the second, the fourth, and the sixth clock signal may be alternately applied to even numbered stages among the stages. The first, the second, the third, the fourth, the fifth, and the sixth clock signal, each having a cycle of 6 horizontal periods and a duty ratio of 1/3, may sequentially have the first level in the first period. The second voltage may correspond to the first level of the first clock terminal, and the first, the second, the third, the fourth, the fifth, and the sixth clock signal may have the second level in the second period.

Each stage may further receive a third control signal having the first level in the first period, and having the second level in the second period. The simultaneous switching unit may further include a ninth transistor coupled between the third junction point and the first voltage terminal the first period, and configured to be turned on in response to the third control signal having the first level.

The simultaneous switching unit may further include a ninth transistor coupled between the third junction point and the first voltage terminal, and configured to be turned on in response to the first level of the first clock terminal. The first clock terminal may have the first level when the scan signal has the second voltage.

Each stage may further include a first capacitor coupled between the gate and a source of the second transistor and a second capacitor coupled between the gate and a source of the third transistor.

According to yet another embodiment, a method of driving a scan driver of a display device including a plurality of scan lines may be provided. Scan signals having a first voltage are sequentially transmitted to the scan lines in response to a plurality of clock signals each having the first level and the second level in turn. The scan signals having the first voltage are simultaneously transmitted to the scan lines in response to a first control signal having the first level while maintaining the clock signals at the second level. The scan signals having a second voltage are simultaneously transmitted to the scan lines in response to a second control signal having the first level while maintaining the clock signals at the second level.

When the scan signals having the first voltage are simultaneously transmitted to the scan lines, the first control signal may be set to the first level after the second control signal is set to the second level.

When the scan signals having the second voltage are simultaneously transmitted to the scan lines, the second control signal may be set to the first level, after the first control signal is set to the second level.

When the scan signals having the first voltage are sequentially transmitted to the scan lines, a third control signal having the first level may be received. When the scan signals having the first voltage are simultaneously transmitted to the scan lines, the third control signal having the second level may be received. When the scan signals having the second voltage are simultaneously transmitted to the scan lines, the third control signal having the second level may be received.

### BRIEF DESCRIPTION OF THE DRAWINGS

FIG. 1 is a block diagram of a display device according to an embodiment.

FIG. 2, FIG. 6, FIG. 9, and FIG. 13 are block diagrams of a scan driver according to an embodiment.

FIG. 3, FIG. 10, FIG. 16, and FIG. 17 are circuit diagrams of one stage in a scan driver according to an embodiment.

FIG. 4, FIG. 7, FIG. 11, and FIG. 14 are signal timing diagrams in a scan operation of a scan driver according to an embodiment.

FIG. 5, FIG. 8, FIG. 12, and FIG. 15 are signal timing diagrams in a simultaneous switching operation of a scan driver according to an embodiment.

### DETAILED DESCRIPTION

Korean Patent Application No. 10-2010-0119885, filed on Nov. 29, 2010, in the Korean Intellectual Property Office, and entitled “Scan Driver and Method of Driving the Same,” is incorporated by reference herein in its entirety.

Embodiments will now be described more fully hereinafter with reference to the accompanying drawings, in which such exemplary embodiments are illustrated. Embodiments may take different forms and should not be construed as limited to the particular embodiments set forth herein.

Throughout this specification and the claims that follow, when it is described that an element is “coupled” to another element, the element may be “directly coupled” to the other element or “electrically coupled” to the other element through a third element.

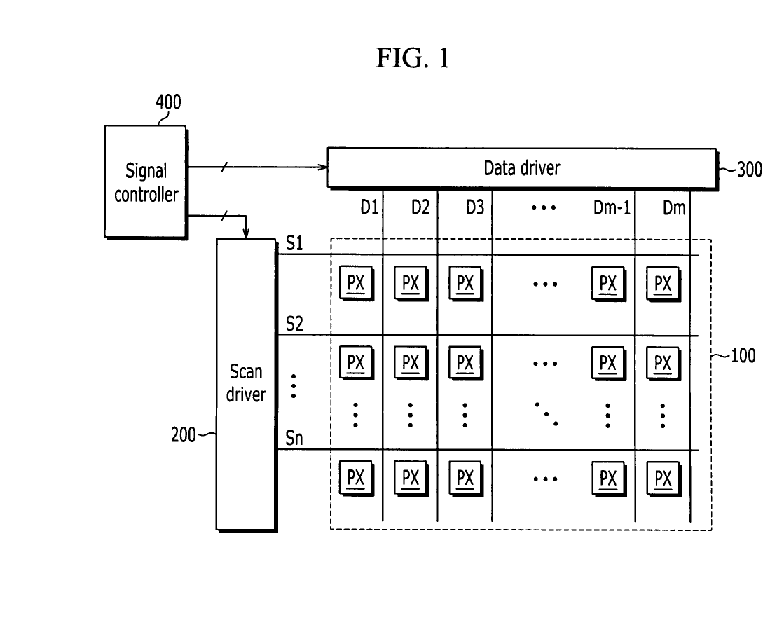

FIG. 1 is a block diagram of a display device according to an embodiment.

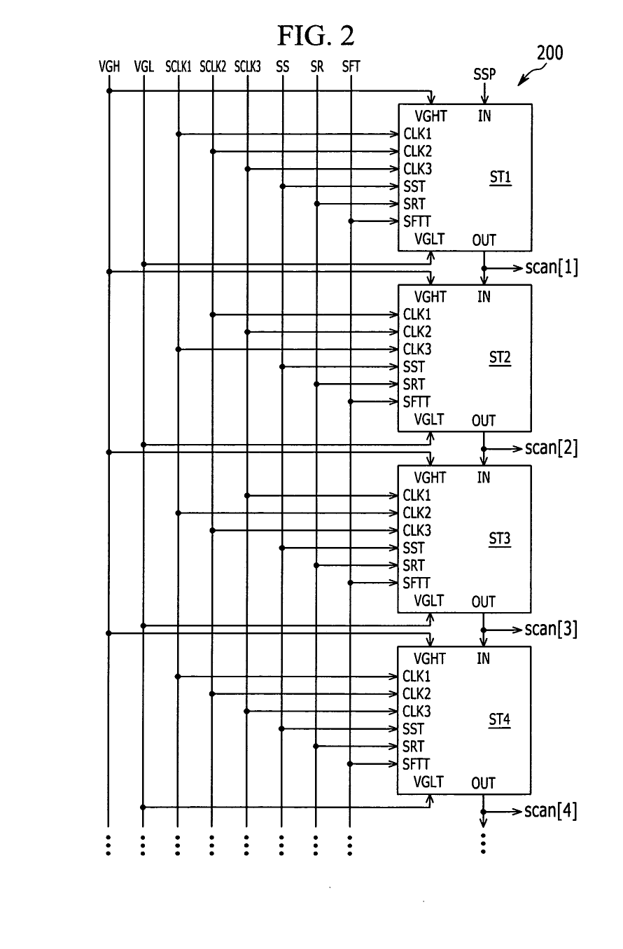

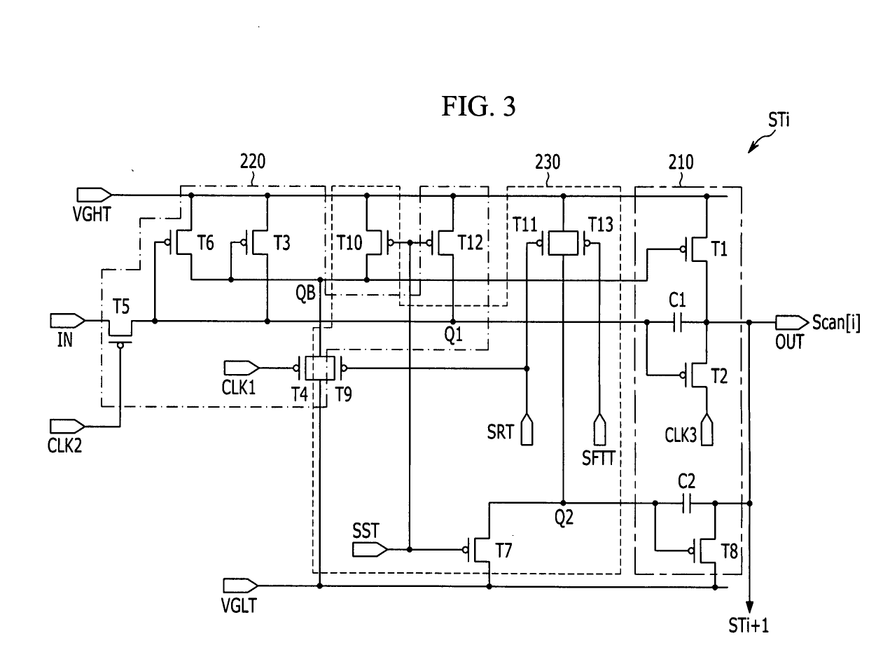

FIG. 2 is a block diagram of a scan driver according to an embodiment. FIG. 3 is a circuit diagram of one stage in the scan driver shown in FIG. 2.

Referring to FIG. 1, the display device includes a display unit 100, a scan driver 200, a data driver 300, and a signal controller 400.

In an equivalent circuit, the display unit 100 includes a plurality of display signal lines S₁ to Sₘ and D₁to Dₘ, and a plurality of pixels PX coupled to the plurality of display signal lines S₁ to Sₘ and D₁ to Dₘ, and arranged in a matrix shape. The display unit 100 may include lower and upper display panels (not shown) that face each other.

The display signal lines S₁ to Sₘ and D₁ to Dₘ includes a plurality of scan line S₁ to Sₙ transmitting scan signals (also referred to as “gate signals”) and a plurality of data lines D₁ to Dₘ transmitting data signals. The scan lines S₁ to Sₙ extend substantially in a row direction and are parallel with one another, and the data lines D₁ to Dₘ extend substantially in a column direction and are parallel with one another.

The scan driver 200 is coupled to the scan lines S₁ to Sₙ and synthesizes a gate-on voltage and a gate-off voltage to generate scan signals, which are applied to the scan lines S₁ to Sₙ. The gate-on voltage is a voltage that is applied to a gate of a transistor to turn on the transistor, and the gate-off voltage is a voltage that is applied to the gate of the transistor to turn off the transistor.

The data driver 300 is coupled to the data lines D₁ to Dₘ, and generates the data signals for representing grayscales and then applies the data signals to the data lines D₁ to Dₘ.

The signal controller 400 controls the scan driver 200 and the data driver 300.

The pixel PX may include a transistor (not shown) having a gate coupled to the scan line and a source or drain coupled to the data line. The transistor transmits the data signal from the data line in response to the gate-on voltage of the scan signal from the scan line. The pixel may further include a light emitting unit for display the grayscale according to the data signal from the transistor. In the case that the display device is a liquid crystal display (LCD), the light emitting unit may include a capacitor for storing the data signal and a liquid crystal layer for displaying the grayscale according to the data signal stored in the capacitor. In the case that the display device is an organic light emitting display, the light emitting unit may include a capacitor for storing the data signal, a driving transistor for outputting a current according to the data signal stored in the capacitor, and an organic light emitting diode (OLED) for displaying the grayscale according to the current from the driving transistor.

Each of the scan driver 200, the data driver 300, and the signal controller 400 may be directly mounted as at least one integrated circuit (IC) chip on the display unit 100 or on a flexible printed circuit film (not shown) in a tape carrier package (TCP). The TCP may be attached to the display unit 100, or may be mounted on a separated printed circuit board (not shown). Alternatively, each of the scan driver 200, the data driver 300, and the signal controller 400 may be integrated with the display unit 100 along with the signal lines S₁ to Sₙ and D₁ to Dₘ and the transistor. The scan driver 200, the data driver 300, and the signal controller 400 may be integrated as a single chip. In this case, at least one of them or at least one circuit device constituting them may be located outside the single chip.

Referring to FIG. 2, the scan driver 200 of FIG. 1 includes a plurality of stages ST₁ to STₙ, and receives a high voltage VGH, a low voltage VGL, at least one clock signal SCLK1, SCLK2, and SCLK3, at least one control signal, and a scan start signal SSP (also referred to as “a scan start pulse”). At least one control signal includes a shift signal SFT, a simultaneous on signal SS (also referred to as “a simultaneous set signal”), and a simultaneous off signal SR (also referred to as “a simultaneous reset signal”). The plurality of stages ST₁ to STₙ are coupled to the plurality of scan lines S₁ to Sₙ, of the display device, respectively, and output the scan signals scan[1] to scan[n] to the corresponding scan lines S₁ to Sₙ.

Each stage, for example i-th stage STᵢ includes an input terminal IN, an output terminal OUT, clock terminals CLK1, CLK2, and CLK3, a shift terminal SFTT, a simultaneous on terminal SST, a simultaneous off terminal SRT, a high voltage terminal VGHT, and a low voltage terminal VGLT.

In the i-th stage STᵢ, the shift terminal SFTT receives the shift signal SFT, and the simultaneous on and off terminals SST and SRT receive the simultaneous on and off signals SS and SR, respectively. The high voltage VGH and the low voltage VGL are applied to the high voltage terminal VGHT and the low voltage terminal VGLT of the i-th stage STᵢ, respectively.

In the plurality of stages ST₁ to STₙ, the clock signals SCLK1, SCLK2, and SCLK3 are alternately applied to the clock terminals CLK1, CLK2, and CLK3. The clock signals SCLK1, SCLK2, and SCLK3 are respectively applied to the clock terminals CLK1, CLK2, and CLK3 when the i is (3j-2). The clock signals SCLK2, SCLK3, and SCLK1 are respectively applied to the clock terminals CLK1, CLK2, and CLK3 when the i is (3j-1). The clock signals SCLK3, SCLK1, and SCLK2 are respectively applied to the clock terminals CLK1, CLK2, and CLK3 when the i is 3j.

The output terminal OUT of the i-th stage STᵢ outputs the scan signal scan[i] having the gate-on voltage or the gate-off voltage to the corresponding the scan line Sᵢ. The input terminal IN of the i-th stage STᵢ is coupled to the output terminal OUT of a previous stage STᵢ₋₁, and receives the scan signal scan[i-1] of the previous stage STᵢ₋₁, i.e., a previous output signal. The output terminal OUT of the i-th stage STᵢ is coupled to the input terminal IN of a next stage STᵢ₊, and transmits the scan signal scan[i] to the next stage STᵢ₊₁.

However, the input terminal IN of the first stage ST₁ receives the scan start signal SSP. The output terminal OUT of the last stage STₙ may be coupled to only the corresponding the scan line Sₙ.

When one scan line is scanned during 1 horizontal period (1H), each of the clock signals SCLK1, SCLK2, and SCLK3 has a cycle of 3H and a duty ratio of 1/3. The phase deference between the adjacent two clock signals is 1 H. Therefore, while one of the three clock signals SCLK1, SCLK2, and SCLK3 has the low voltage, the other clock signals may have the high voltage. While the scan driver 200 sequentially applies the gate-on voltage to the plurality of scan lines S₁ to Sₙ, the shift signal SFT may have the gate-on voltage and the simultaneous on and off signals SS and SR may have the gate-off voltage. While the scan driver 200 simultaneously applies the gate-on voltage to the scan lines S₁ to Sₙ, the simultaneous on signal SS may have the gate-on voltage. While the scan driver 200 simultaneously applies the gate-off voltage to the scan lines S₁ to Sₙ, the simultaneous off signal SR may have the gate-on voltage.

Referring to FIG. 3, each stage, for example the i-th stage STᵢ includes an output unit 210, a sequential switching unit 220, and a simultaneous switching unit 230. Each stage includes include p-channel metal-oxide semiconductor (PMOS) transistors T1 to T13, and capacitors C1 and C2. When PMOS transistors are used, the gate-on voltage is a low voltage and the gate-off voltage is a high voltage. Alternatively, the transistors T1 to T13 may be n-channel metal-oxide semiconductor (NMOS) transistors. In this case, the gate-on voltage is the high voltage and the gate-off voltage is the low voltage.

The output unit 210 includes the transistors T1, T2 and T8, and the capacitors C1 and C2. The output unit 210 is coupled to the high voltage terminal VGHT, the low voltage terminal VGLT, the output terminal OUT, and the clock terminal CLK3. A drain of the transistor T1 and sources of the transistors T2 and T8 are coupled to the output terminal OUT. A source of the transistor T1 is coupled to the high voltage terminal VGHT, a drain of the transistor T2 is coupled to the clock terminal CLK3, and a drain of the transistor T8 is coupled to the low voltage terminal VGLT. A gate of the transistor T1 is coupled to a junction point QB, a gate of the transistor T2 is coupled to a junction point Q1, and a gate of the transistor T8 is coupled to a junction point Q2. The capacitor C1 is coupled between the gate and the source of the transistor T2, and the capacitor C2 is coupled between the gate and the source of the transistor T8. The capacitors C1 and C2 may be parasitic capacitors substantially formed between gate and drain/source regions of the transistors T2 and T2 in the manufacturing process.

The sequential switching unit 220 includes the transistors T3 to T6 and T12, and is coupled to the input terminal IN, the high voltage terminal VGHT, the low voltage terminal VGLT, the clock terminal CLK1 and CLK2, the simultaneous on terminal SST, and the junction points QB and Q1. A drain of the transistor T5 is coupled to the input terminal IN, and a gate of the transistor T3, a drain of the transistor T6 and a source of the transistor T4 are coupled to the junction point QB. A gate of the transistor T6, drains of the transistors T3 and T12, and a source of the transistor T5 are coupled to the junction point Q1. Sources of the transistors T3, T6 and T12 are coupled to the high voltage terminal VGHT, and a drain of the transistor T4 is coupled to the low voltage terminal VGLT. A gate of the transistor T4 is coupled to the clock terminal CLK1, a gate of the transistor T5 is the clock terminal CLK2, and a gate of the transistor T12 is coupled to the simultaneous on terminal SST.

The simultaneous switching unit 230 includes the transistors T7, T9 to T11 and T13, and is coupled to the simultaneous on and off terminals SST and SRT, the shift terminal SFTT, the high voltage terminal VGHT, the low voltage terminal VGLT, and the junction points QB and Q2. Sources of the transistors T10, T11 and T13 are coupled to the high voltage terminal VGHT, and drains of the transistors T7 and T9 are coupled to the voltage terminal VGLT. Gates of the transistors T7 and T10 are coupled to the simultaneous on terminal SST, gates of the transistors T9 and T11 are coupled to the simultaneous off terminal SRT, and a gate of the transistor T13 is coupled to the shift terminal SFTT. A source of the transistor T7 and drains of the transistors T11 and T13 are coupled to the junction point Q2, and a source of the transistor T9 and a drain of the transistor T10 are coupled to the junction point QB.

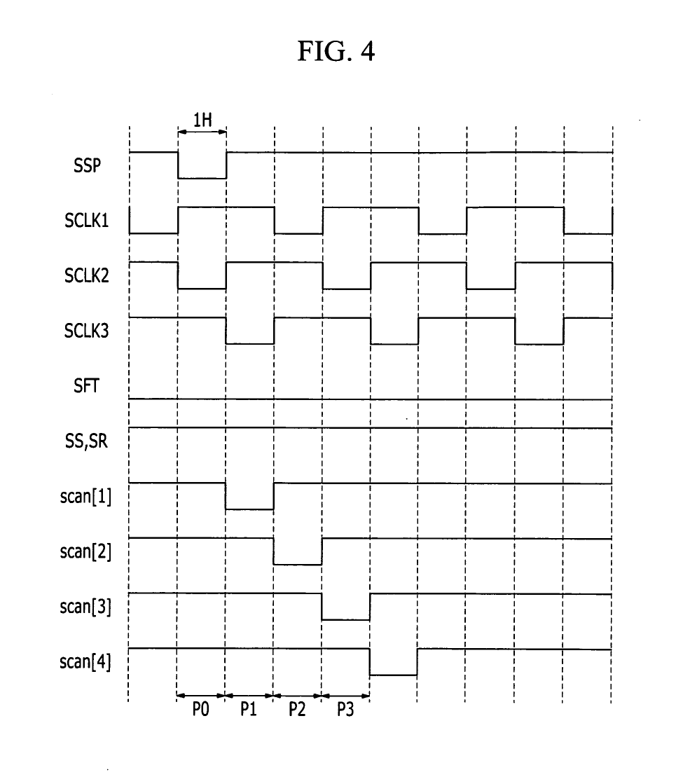

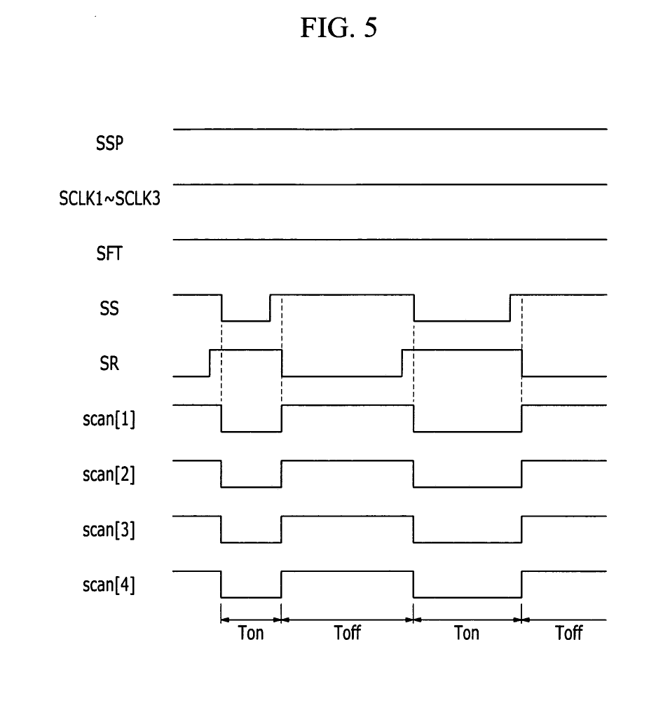

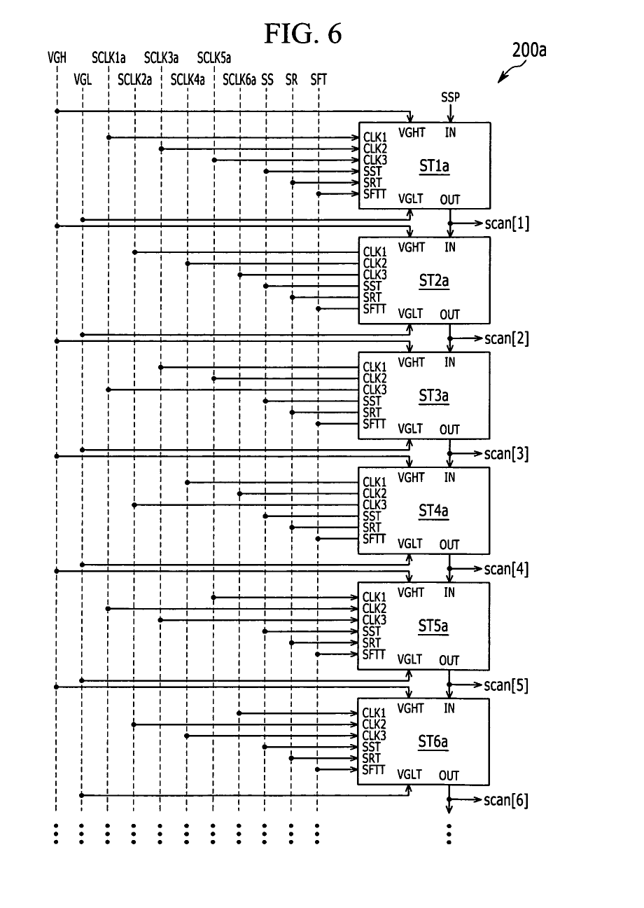

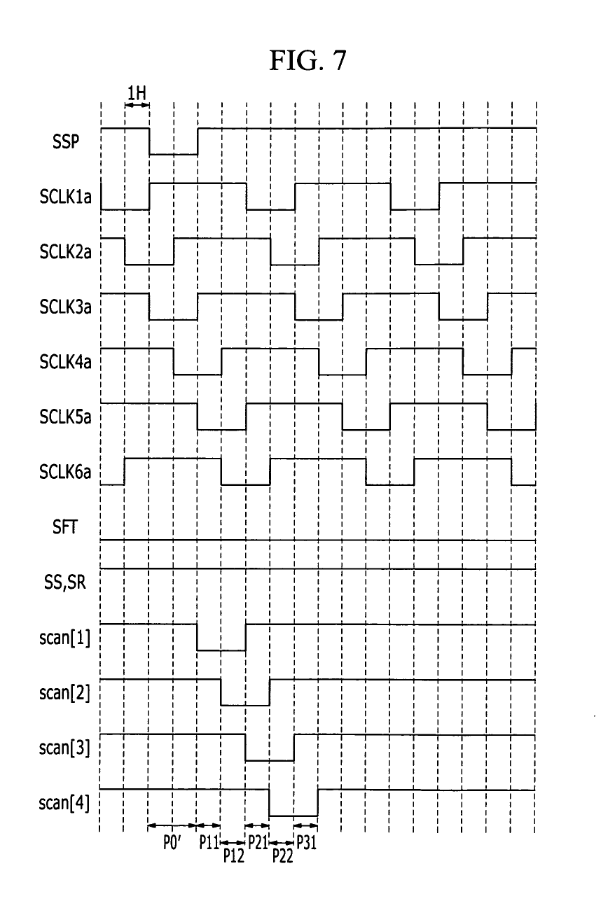

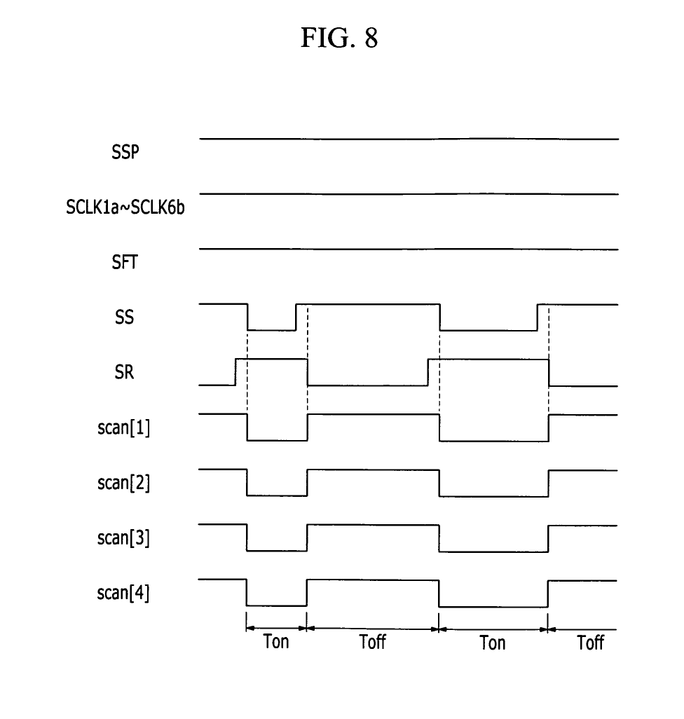

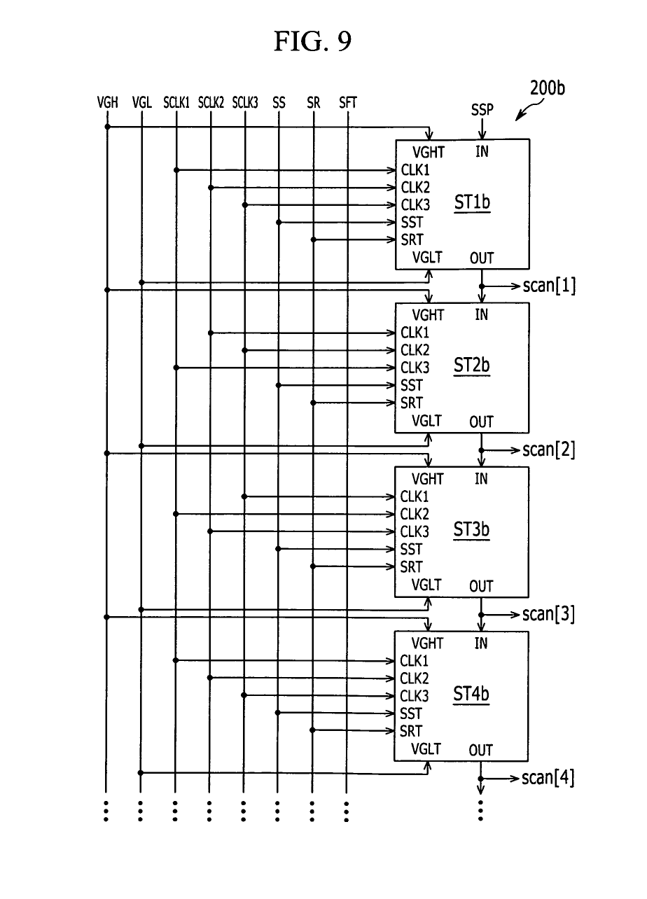

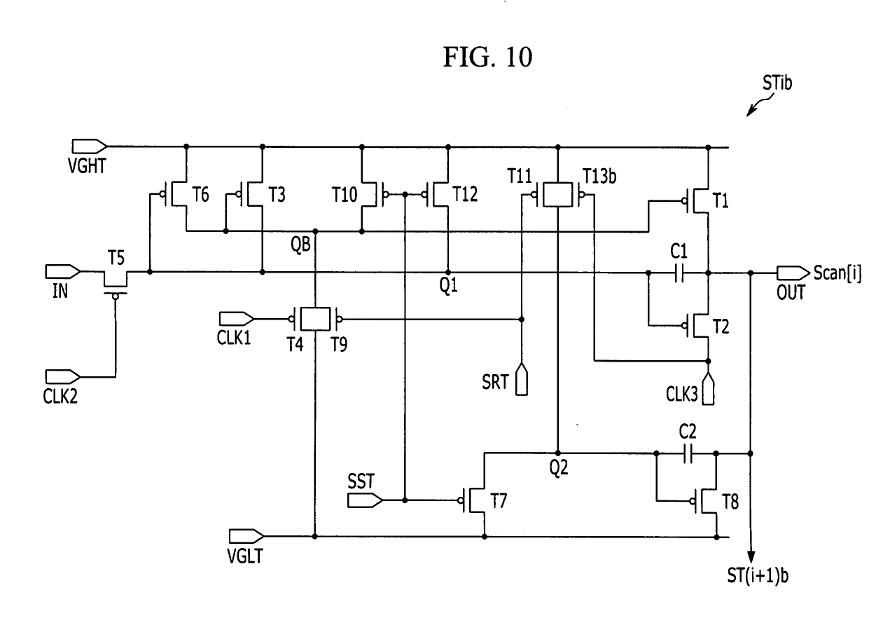

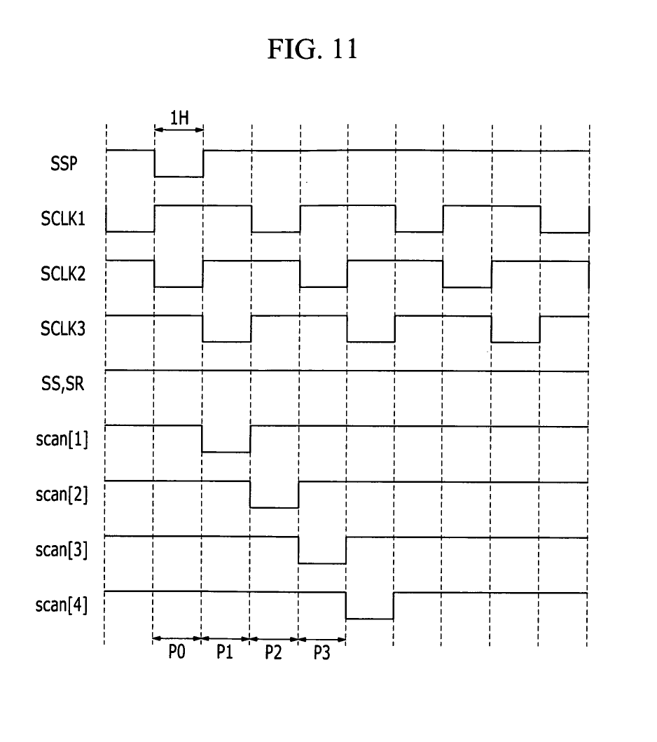

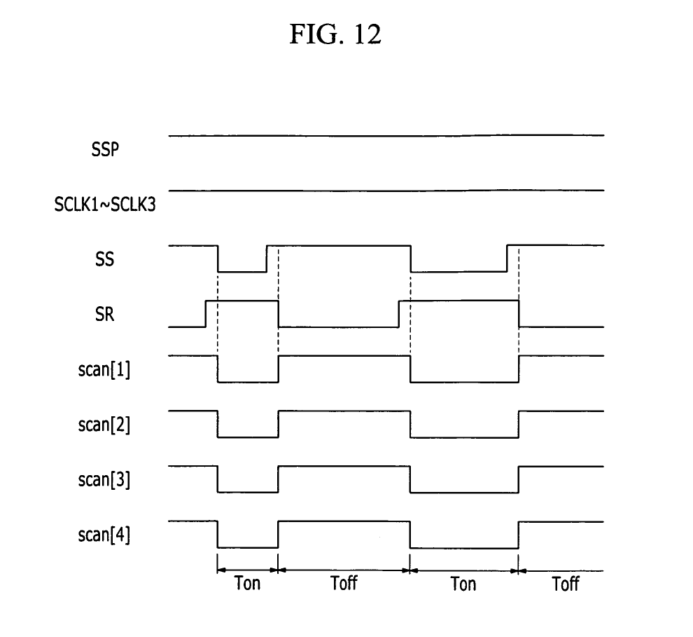

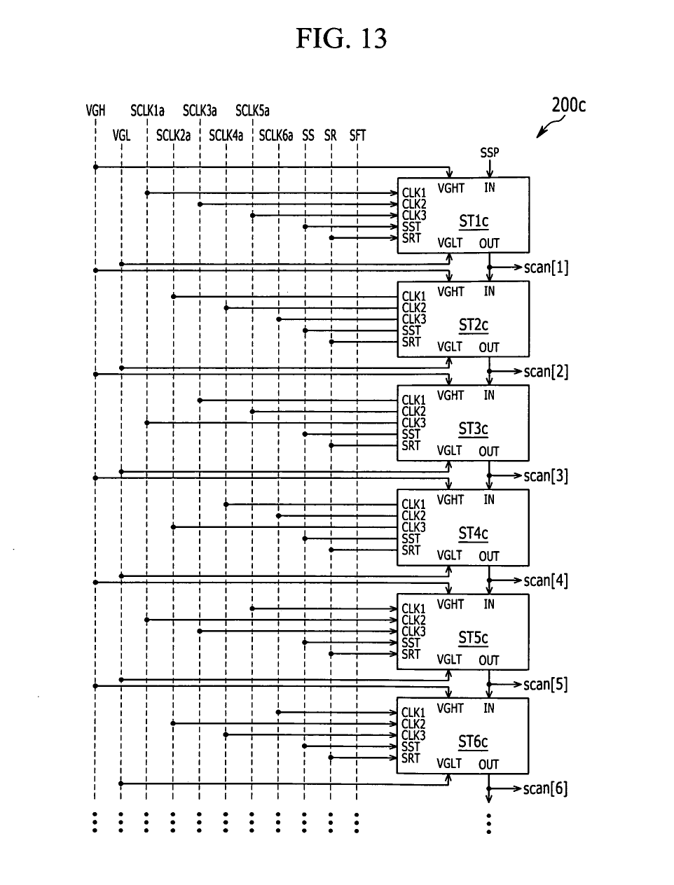

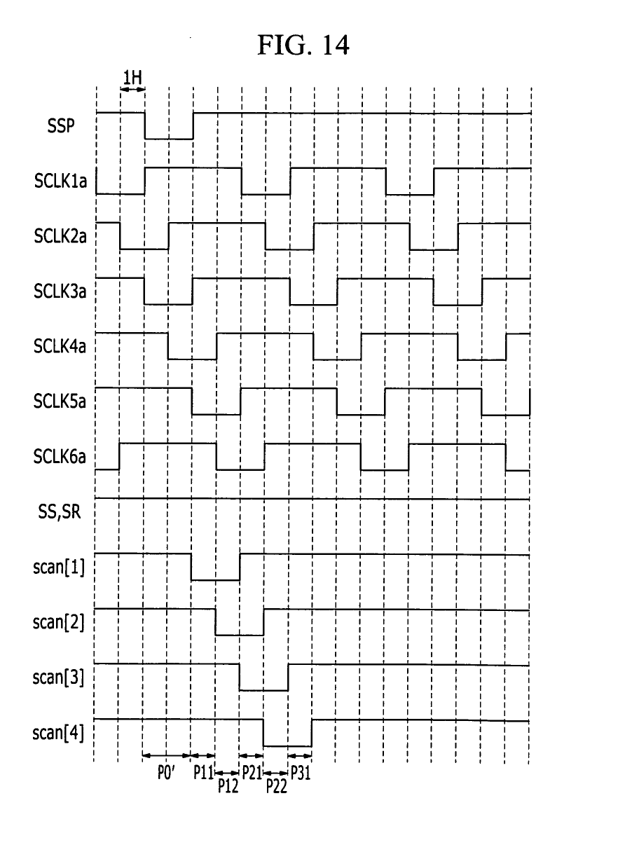

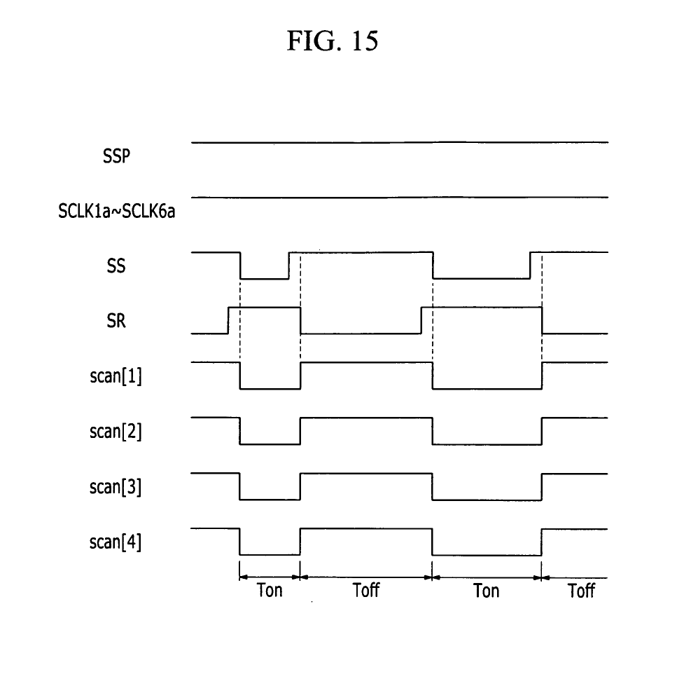

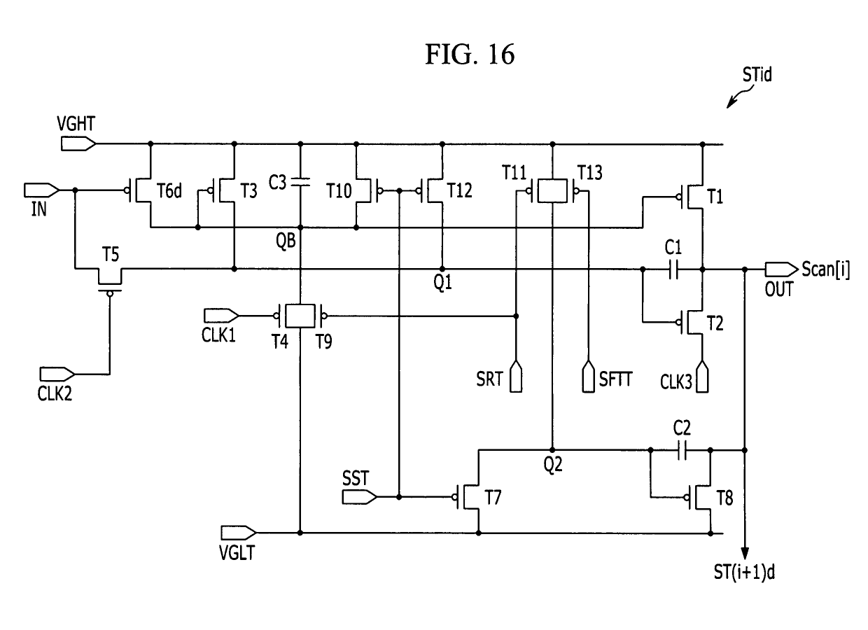

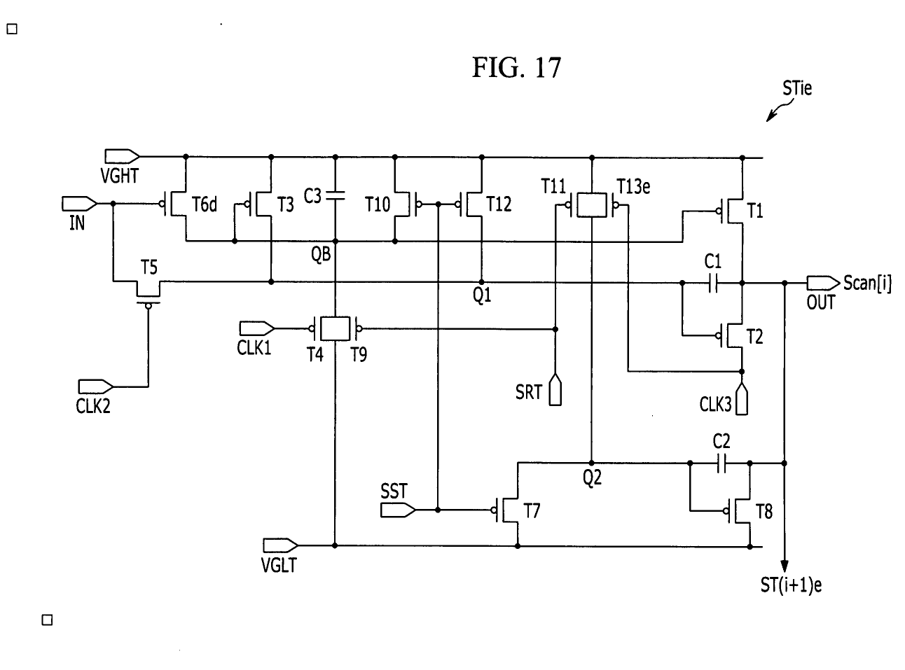

An operation of the scan driver according to an embodiment will be described with reference to FIG. 4 and FIG. 5.

FIG. 4 is a signal timing diagram in a scan operation of a scan driver according to an embodiment. FIG. 5 is a signal timing diagram in a simultaneous switching operation of a scan driver according to an embodiment.

It is assumed in FIG. 4 and FIG. 5 that a high level and a low level of each of clock signals and control signals are equal to the high voltage VGH of the high voltage terminal VGHT and the low voltage VGL of the low voltage terminal VGLT, respectively. It is assumed that each transistor of each stage STᵢ are turned off in response to the high level, i.e., the high voltage of the clock signal or the control signal, and are turned on in response to the low level, i.e., the low voltage of the clock signal or the control signal.

The scan operation, i.e., a shift register operation of the scan driver 200 will be described with reference to FIG. 4.

Referring to FIG. 4, during a scan period, the shift signal SFT has the low voltage VGL, and the simultaneous on and off signals SS and SR have the high voltage VGH. The transistors T7, T9, T10, T11, and T12 are turned off, and the transistor T13 is turned on such that a voltage of the junction point Q2 increases to the high voltage VGH. Accordingly, the transistor T8 is turned off to prevent a voltage output of the output terminal OUT by the transistor T8.

When the scan start signal SSP having the low voltage VGL during the 1H is applied in a period P0, the scan operation starts. In the period P0, since the clock signal SCLK2 has the low voltage VGL, and the clock signals SCLK1 and SCLK3 have the high voltage VGH, the input terminal IN and the clock terminal CLK2 of the first stage ST₁ are set to the low voltage, and the clock terminals CLK1 and CLK3 of the first stage ST₁ are set to the high voltage. The transistor T5 is turned on to decrease a voltage of the junction point Q1 to the low voltage, and the transistor T6 is turned on to increase a voltage of the junction point QB to the high voltage. Accordingly, the transistor T1 is turned off, and the transistor T2 is turned on. The scan signal scan[1] output from the output terminal OUT of the first stage ST₁ is maintained at the high voltage of the clock terminal CLK3, and the difference between the high voltage and the low voltage is stored in the capacitor C1.

During a period P1, the clock signal SCLK3 has the low voltage, and the scan start signal SSP has the high voltage. The clock terminal CLK3 of the first stage ST₁ is set to the low voltage, and the input terminal IN and the clock terminals CLK1 and CLK2 of the first stage ST₁ are set to the high voltage. The transistors T4 and T5 are turned off to float the junction point Q1. The transistor T6 is maintained in an on state such that the transistor T1 is maintained in an off state. Since the voltage of the floated junction point Q1 is the low voltage, the transistor T2 is maintained in the on state such that the voltage of the output terminal OUT decreases to the low voltage. The voltage of the junction point Q1 decreases to a voltage lower than the low voltage VGL by a bootstrap of the capacitor C1 such that the transistor T2 is fully turned on. As a result, the voltage of the output terminal OUT is set to the low voltage VGL. The first stage ST₁ outputs the scan signal scan[1] having the low voltage VGL, i.e., the gate-on voltage. The stage ST₁ maintains the low voltage, which receives through the transistor T5 during the period P0, using the capacitor Cl and turns on the transistor T2, thereby outputting the low voltage of the clock signal SCLK3 as the scan signal scan[1].

In the period P1, since the scan signal scan[1] and the clock signal SCLK3 have the low voltage, and the clock signals SCLK 1 and SCLK2 have the high voltage, the input terminal IN and the clock terminal CLK2 of the second stage ST₂ are set to the low voltage, and the clock terminals CLK1 and CLK3 of the second stage ST₂ are set to the high voltage. Therefore, the second stage ST₂ operates in a similar manner as the first stage ST₁ of the period P0 so as to output the scan signal scan[2] having the high voltage, i.e., the gate-off voltage to the output terminal OUT.

During a period P2, the clock signal SCLK1 has the low voltage such that the clock terminal CLK1 of the first stage ST₁ is set to the low voltage, the input terminal IN and the clock terminals CLK2 and CLK3 of the first stage ST₁ are set to the high voltage. The transistor T4 is turned on to decrease the voltage of the junction point QB to the low voltage such that transistor T1 is turned on. The transistor T3 is turned on to increase the voltage of the junction point Q1 to the high voltage such that the transistor T2 is turned off. Accordingly, the first stage ST₁ outputs the scan signal scan[1] having the high voltage to the output terminal OUT.

In the period P2, since the scan signal scan[1] and the clock signal SCLK1 have the low voltage and the clock signals SCLK2 and SCLK3 have the high voltage, the second stage ST₂ operates in a similar manner as the first stage ST₁ of the period P1 to output the scan signal scan[2] having the low voltage to the output terminal OUT. Further, since the third stage ST₃ receives the scan signal scan[2] having the low voltage at the input terminal IN, the third stage ST₃ operates in a similar manner as the first stage ST₁ of the period P0.

Subsequently, during a period P3, the clock signal SCLK2 has the low voltage such that the clock terminal CLK2 of the first stage ST₁ is set to the low voltage and the input terminal IN and the clock terminals CLK1 and CLK3 of the first stage ST₁ are set to the high voltage. The transistor T5 is turned on to maintain the junction point QI at the high voltage such that the transistor T2 is maintained in the off state. The transistors T4 and T6 are turned off to float the junction point QB such that the transistor T1 is maintained in the on state. Accordingly, the first stage ST₁ continuously outputs the scan signal scan[1] having the high voltage to the output terminal OUT. Thus, after the period P2, the stage ST₁ turns on the transistor T1, thereby outputting the scan signal scan[1] having the high voltage.

In the period P3, since the clock signal SCLK2 has the low voltage and the scan signal scan[1] has the high voltage, the second stage ST₂ operates in a similar manner as the first stage ST₁ of the period P2 to output the scan signal scan[2] having the high voltage. Accordingly, the third stage ST₃ operates in a similar manner as the first stage ST₁ of the period P1 to output the scan signal scan[3] having the low voltage.

The scan driver 200 can sequentially scan signals scan[1] to scan[n] having the low voltage, i.e., the gate-on voltage to the scan lines S_{I} to Sₙ in response to the clock signals SCLK1, SCLK2, and SCLK3, while the shift signal SFT has the low voltage and the simultaneous on and off signals SS and SR have the high voltage.

The simultaneous switching operation of the scan driver 200 will be described with reference to FIG. 5.

Referring to FIG. 5, the shift signal SFT, the clock signals SCLK1, SCLK2, and SCLK3, and the scan start signal SSP have the high voltage during a simultaneous switching period,

The transistors T4, T5, and T13 are turned off.

A simultaneous on period Ton of the simultaneous switching period starts when the simultaneous on signal SS has the low voltage and the simultaneous off signal SR has the high voltage.

In the stages ST₁ to ST₁ the transistors T9 and T11 are turned off, and the transistors T7, T10, and T12 are turned on. Accordingly, the voltages of the junction points Q1 and QB increase to the high voltage, and the voltage of the junction point Q2 decreases to the low voltage. The transistors T1 and T2 are turned off by the junction points Q1 and QB to prevent a voltage output by the transistors T1 and T2. The transistor T8 is turned on by the junction point Q2 to decrease the voltage of the output terminal OUT to the low voltage. The voltage of the junction point Q2 decreases to a voltage lower than the low voltage VGL by a bootstrap of the capacitor C2 such that the transistor T8 is fully turned on. As a result, the voltage of the output terminal OUT becomes the low voltage VGL. Accordingly, the stages ST₁ to STₙ output the scan signals scan[1] to scan[n] having the low voltage, i.e., the gate-on voltage to the scan lines S₁ to Sₙ such that all transistors of the pixels PX, whose gates are coupled to the scan signals S₁ to Sₙ, are turned on.

In a simultaneous off period Toff of the simultaneous switching period, the simultaneous on signal SS has the high voltage, and the simultaneous off signal SR has the low voltage.

In the stages ST₁ to STₙ, the transistors T7, T10, and T12 are turned off, and the transistors T9 and T11 are turned on. Accordingly, the voltage of the junction point Q2 increases to the high voltage, and the voltage of the junction point QB decreases to the low voltage. The transistor T8 is turned off by the junction point Q2 prevents a voltage output by the transistor T8. The transistor T3 is turned on by the junction point QB to maintain the junction point Q1 at the high voltage. The transistor T2 is maintained in the off state, and the transistor T1 is turned on to set the output terminal OUT to the high voltage. Therefore, the stages ST₁ to STₙ output the scan signals scan[1] to scan[n] having the high voltage, i.e., the gate-off voltage to the scan lines S₁ to Sₙ , such that all the transistors having the gates coupled to the scan signals S₁ to Sₙ are turned off.

If the simultaneous on and off signals SS and SR are simultaneously set to the low voltage in the simultaneous switching period Ton/Toff, the transistors T7, T9, T10, and T11 are simultaneously turned on. A short-circuit current may flow from the high voltage terminal VGHT to the low voltage terminal VGLT via the transistors T10 and T9 or the transistors T11 and T7. Accordingly, as shown in FIG. 5, at the time of transiting to the simultaneous on period Ton, the simultaneous on signal SS may be changed to the low voltage after the simultaneous off signal SR is changed to the high voltage. At the time of transiting to the simultaneous off period Toff, the simultaneous off signal SR may be changed to the low voltage after the simultaneous on signal SS is changed to the high voltage.

FIG. 6 is a block diagram of a scan driver according to another embodiment,

FIG. 7 is a signal timing diagram in a scan operation of a scan driver shown in FIG. 6. FIG. 8 is a signal timing diagram in a simultaneous switching operation of a scan driver shown in FIG. 6.

Referring to FIG. 6, the scan driver 200a includes a plurality of stages ST₁ₐ to STₙₐ, and receives a high voltage VGH, a low voltage VGL, six clock signals SCLK1a, SCLK2a, SCLK3a, SCLK4a, SCLK5a, and SCLK6a, at least one control signal, and a scan start signal SSP. Each of the clock signals SCLK1a, SCLK2a, SCLK3a, SCLK4a, SCLK5a, and SCLK6a has a cycle of 6H and a duty ratio of 1/3. The phase difference between the two adjacent clock signals is 1H. Therefore, each of the clock signals SCLK1a, SCLK2a, SCLK3a, SCLK4a, SCLK5a, and SCLK6a has a low voltage during 2H in one cycle.

Each stage STᵢₐ have the substantially same structure as the stage STᵢ shown in FIG. 3. The clock signals SCLK1a, SCLK3a, and SCLK5a are alternately input to the clock terminals CLK1, CLK2, and CLK3 of odd numbered stages STᵢₐ, ST₃ₐ, . . . , ST₍ₙ₋₁₎ₐ among the stages ST₁ₐ to STₙₐ. The clock signals SCLK2a, SCLK4a, and SCLK6a are alternately input to the clock terminals CLK1, CLK2, and CLK3 of even numbered stages ST₂ₐ, ST₄ₐ, . . . , STₙₐ among the stages ST₁ₐ to STₙₐ. The clock signals SCLK1a, SCLK3a, and SCLK5a are respectively input to the clock terminals CLK1, CLK2, and CLK3 when i is (6j-5). The clock signals SCLK3a, SCLK5a, and SCLK1a are respectively input to the clock terminals CLK1, CLK2, and CLK3 when i is (6j-3). The clock signals SCLK5a, SCLK1a, and SCLK3a are respectively input to the clock terminals CLK1, CLK2, and CLK3 when i is (6j-1). The clock signals SCLK2a, SCLK4a, and SCLK6a are respectively input to the clock terminals CLK1, CLK2, and CLK3 when i is (6j-4). The clock signals SCLK4a, SCLK6a, and SCLK2a are respectively input to the clock terminals CLK1, CLK2, and CLK3 when i is (6j-2). The clock signals SCLK6a, SCLK2a, and SCLK4a are respectively input to the clock terminals CLK1, CLK2, and CLK3 when i is 6j.

Referring to FIG. 7, a scan operation starts when the scan start signal SSP having the low voltage during 2H is applied in a period P0′. In the period P0′, the clock signal SCLK3a has a low voltage, and the clock signals SCLK1a and SCLK5a have a high voltage. Accordingly, the first stage ST₁ₐ operates in a similar manner as the first stage ST₁ of the period P0 shown in FIG. 4, to output the scan signal scan[1] having the high voltage and store a voltage in the capacitor C1.

Subsequently, in periods P11 and P12, the clock signal SCLK5a has the low voltage and the clock signals SCLK1a and SCLK3a have the high voltage during 2H. Accordingly, the first stage STᵢₐ operates in a similar manner as first stage ST₁ of the period P1 shown in FIG. 4, to output the scan signal scan[1] having the low voltage during 2H. In the period P11, since the clock signal SCLK4a and the scan signal scan[1] have the low voltage, and the clock signals SCLK2a and SCLK6a have the high voltage, the second stage ST₂ₐ operates in a similar manner as the second stage ST₂ of the period P1 shown in FIG. 4. Accordingly, the second stage ST₂ₐ outputs the scan signal scan[2] having the high voltage, and stores a voltage in the capacitor C1.

In the period P12 and a period P21, the clock signal SCLK6a has the low voltage and the clock signals SCLK2a and SCLK4a have the high voltage during 2H. Since the second stage ST₂ₐ stores the voltage in the capacitor C1 in the period P11, the second stage ST₂ₐ operates in a similar manner as the second stage ST₂ of the period P2 shown in FIG. 4 to output the scan signal scan[2] having the low voltage during 2H. In the period P12, since the clock signal SCLK5a and the scan signal scan[2] have the low voltage, and the clock signals SCLK1a and SCLK3a have the high voltage, the third stage ST₃ₐ operates in a similar manner as the third stage ST₃ of the period P2 shown in FIG. 4. Accordingly, the third stage ST₃ₐ outputs the scan signal scan[3] having the high voltage and stores a voltage in the capacitor C1.

In the period P21 and a period P22, the clock signal SCLK1a has the low voltage and the clock signals SCLK3a and SCLK5a have the high voltage during 2H.

Since the third stage ST₃ₐ stores the voltage in the capacitor C1 in the period P12, the third stage ST₃ₐ operates in a similar manner as the third stage ST₃ of the period P3 shown in FIG. 4 to output the scan signal scan[3] having the low voltage during 2H. In the period P21, since the clock signal SCLK6a and the scan signal scan[3] have the low voltage, and the clock signals SCLK2a and SCLK4a have the high voltage, the fourth stage ST₄ₐ outputs the scan signal scan[4] having the high voltage and stores a voltage in the capacitor C1.

In the period P22 and a period P31, since the clock signal SCLK2a has the low voltage and the clock signals SCLK4a and SCLK6a have the high voltage during 2H, the fourth stage ST₄ₐ outputs the scan signal scan[4] having the low voltage during 2H. In the period P22, since the clock signal SCLKla and the scan signal scan[4] have the low voltage, and the clock signals SCLK3a and SCLK5a have the high voltage, the fifth stage ST₅ₐ outputs the scan signal scan[5] having the high voltage and stores a voltage in the capacitor C1.

The stages ST₁ₐ to STₙₐ can sequentially output the scan signals scan[1] to scan[n] having the low voltage during 2H by shifting the scan signals by 1H.

Referring to FIG. 8, in the simultaneous switching period, the shift signal SFT, the clock signals SCLK1a to SCLK6a, and the scan start signal SSP have the high voltage. In the simultaneous on period Ton, the simultaneous on signal SS has the low voltage, and the simultaneous off signal SR has the high voltage. In the simultaneous off period Toff, the simultaneous on signal SS has the high voltage, and the simultaneous off signal SR has the low voltage. As described with reference to FIG. 5, the stages ST₁ₐ to ST. outputs the scan signals scan[1] to scan[n] having the low voltage in the simultaneous on period Ton, and outputs the scan signals scan[1] to scan[n] having the high voltage in the simultaneous off period Toff.

FIG. 9 is a block diagram of a scan driver according to another embodiment.

FIG. 10 is a circuit diagram of one stage in a scan driver shown in FIG. 9. FIG. 11 is a signal timing diagram in a scan operation of a scan driver shown in FIG. 9. FIG. 12 is a signal timing diagram in a simultaneous switching operation of a scan driver shown in FIG. 9.

Referring to FIG. 9, the scan driver 200b includes a plurality of stages ST_{ib} to ST_{rib}, and does not receive a shift signal SFT among control signals differently from the scan driver 200 shown in FIG. 2.

Referring to FIG. 10, a gate of a transistor T13b in each stage ST_{ib} is coupled to a clock terminal CLK3 differently from the stage STᵢ shown in FIG. 3

Referring to FIG. 11, when the scan driver 200b performs the scan operation, i.e., the shift register operation, the control signals SS and SR have the high voltage. When the clock terminal CLK3 has the low voltage, the transistor T13b is turned on to increase a voltage of a junction point Q2 to the high voltage. Subsequently, when the clock terminal CLK3 has the high voltage, the junction point Q2 is floated such that the junction point Q2 is maintained as the high voltage. Accordingly, the transistor T8 is maintained in the off state, and a voltage the output terminal OUT of each stage ST_{ib} can be determined by the transistors T1 and T2. In this case, since the clock terminal CLK3 has the low voltage while each stage ST_{ib} outputs the scan signal scan[i] having the low voltage, the transistor T8 can be surely turned off by the high voltage transmitted from the transistor T13b.

Referring to FIG. 12, in the simultaneous on period Ton and the simultaneous off period Toff, the clock signals SCLK1 to SCLK3 have the high voltage such that the high voltage is applied to the gate of the transistor T13b. Accordingly, the stages STₙ, to ST_{nb} operate in a similar manner as the stages ST₁ to STₙ of the simultaneous on and off periods Ton and the Toff shown in FIG. 5.

FIG. 13 is a block diagram of a scan driver according to another embodiment. FIG. 14 is a signal timing diagram in a scan operation of a scan driver shown in FIG. 13. FIG. 15 is a signal timing diagram in a simultaneous switching operation of a scan driver shown in FIG. 13.

Referring to FIG. 13, the scan driver 200c includes a plurality of stages ST_{1c} to ST_{nc}, and does not receive a shift signal SFT among control signals differently from the scan driver 200a shown in FIG. 6. Each stage ST_{ic} may have the substantially same structure as the stage ST_{ib} shown in FIG. 10.

Referring to FIG. 14, when the scan driver 200c performs the scan operation, the control signals SS and SR have the high voltage, and the clock terminal CLK3 alternately has the low voltage and high voltage. Accordingly, the transistor T8 is maintained in the off state. Since the clock terminal CLK3 has the low voltage when each stage ST_{ic} outputs the scan signal scan[i] having the low voltage, the transistor T8 can be surely turned off by the high voltage transmitted from the transistor T13b.

Referring to FIG. 15, in the simultaneous on period Ton and the simultaneous off period Toff, since the clock signals SCLK1a to SCLK6a have the high voltage, the stages ST_{1c} to ST_{nc} operate in a similar manner as the stages ST_{1b} to ST_{nb} of the simultaneous on and off periods Ton and the Toff shown in FIG. 12.

FIG. 16 and FIG. 17 are respectively circuit diagrams of one stage in a scan driver according to another embodiment.

Referring to FIG. 16, each stage ST_{id} further includes a capacitor C3 and a gate of transistor T6d is coupled to an input terminal IN, differently from the stage STᵢ shown in FIG. 3

The capacitor C3 is coupled between a high voltage terminal VGHT and a junction point QB.

A scan operation of the scan driver 200d will be described based on one stage, i.e., the first stage ST_{1d}.

In the period P0 of FIG. 4, since the low voltage is applied to the input terminal IN and the clock terminal CLK2 in the first stage ST_{1d}, the transistors T5 and T6d are turned on such that the first stage ST_{1d} operates in a similar manner as the stage ST₁ shown in FIG. 3. As a result, a junction point Q1 is set to the low voltage, and a junction point QB is set to the high voltage.

In the period P1 of FIG. 4, since the high voltage is applied to the input terminal IN and the clock terminal CLK2 of the first stage ST_{1d}, the transistors T5 and T6d are turned off. Accordingly, the junction point Q1 is floated in a low voltage state such that the first stage ST_{1d} operates in a similar manner as the stage ST₁ shown in FIG. 3 to the scan signal scan[1] having the low voltage. The junction point QB is floated in a high voltage state such that transistor T1 is maintained in the off state. When the output terminal OUT is set to the low voltage, the voltage of the junction point QB is maintained by the capacitor C3.

Subsequently, the low voltage is applied to the clock terminal CLK1 such that the transistors T4 and T3 are turned on. As a result, the voltage of the junction point QB decreases to the low voltage, and the voltage of the junction point Q1 increases to the high voltage. When the low voltage is applied to the clock terminal CLK2, the transistor T5 is turned on such that the junction point Q1 is maintained in the high voltage state and the junction point QB is floated in the low voltage state. When the low voltage is applied to the clock terminal CLK3, the junction points Q1 and QB are maintained in the floating state. Accordingly, the stage ST_{1d} continuously outputs the scan signal scan[1] having the high voltage.

When the scan driver 200d performs the scan operation, each stage ST_{id} operates in a similar manner as the stage STᵢ shown in FIG. 3 and FIG. 4.

A simultaneous switching operation of the scan driver 200d will be described.

In the simultaneous on period Ton, the high voltage is applied to the input terminal IN, the clock terminals CLK1 to CLK3, the shift terminal SFTT, and the simultaneous off terminal SRT, and the low voltage is applied to the simultaneous on terminal SST. Accordingly, each stage ST_{id} operates in a similar manner as the stage STᵢ of the simultaneous on period Ton shown in FIG. 5.

In the simultaneous off period Toff, the high voltage is applied to the input terminal IN, the clock terminals CLK1 to CLK3, the shift terminal SFTT, and the simultaneous on terminal SST, and the low voltage is applied to the simultaneous off terminal SRT. Accordingly, each stage ST_{id} operates in a similar manner as the stage STᵢ of the simultaneous off period Toff shown in FIG. 5.

In this case, when the simultaneous off period Toff starts by setting the simultaneous off terminal SRT to the low voltage, the low voltage of the simultaneous on period Ton may be continuously applied to the input terminal IN. The transistor T9 may be turned on while the transistor T6d is the on state. As a result, the high voltage and the low voltage are simultaneously applied to the junction point QB such that the race may occur. Accordingly, in order to change the voltage of the junction point QB to the low voltage to successfully perform the simultaneous off operation, a channel size of the transistor T9 may be designed to be equal to or greater than a channel size of the transistor T6d. Here, the channel size of the transistor is a ratio of a channel width to a channel length of the transistor.

The stages ST_{1d} to ST_{nd} may be applicable to the scan driver 200a described with reference to FIG. 6 to FIG. 8.

Referring to FIG. 17, a gate of a transistor T13e in each stage STᵢₑ is coupled to a clock terminal CLK3 differently from the stage ST_{id} shown in FIG. 16. The stage STᵢₑ operates in a similar manner as the stage ST_{id} shown in FIG. 16, as described with reference to FIG. 9 to FIG. 12.

By way of summation and review, a scan driver is disclosed having a function for simultaneously applying a predetermined voltage to the scan lines, as well as a shift register function for sequentially applying the scan pulse to the scan lines.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made.

What is claimed is:

1. A scan driver of a display device including a plurality of scan lines, the scan driver comprising:
a plurality of stages configured to transmit scan signals to the scan lines,
wherein each stage of the plurality of stages includes:
an input terminal for receiving a scan signal from a previous stage,
an output terminal,
an output unit coupled to the output terminal, and configured to output a corresponding scan signal of the scan signals to the output terminal,
a sequential switching unit coupled to the input terminal, and configured to control the output unit such that the output unit of each stage sequentially outputs the scan signals having a first voltage in a first period, and
a simultaneous switching unit configured to control the output unit such that the output unit of each stage simultaneously outputs the scan signals having a predetermined voltage in a second period.

2. The scan driver as claimed in claim 1, wherein:
each stage of the plurality of stages receives a control signal having a first level in the first period, and having a second level in the second period.

3. The scan driver as claimed in claim 1, wherein:
each stage of the plurality of stages receives a first and a second control signal,
wherein the second period includes a third period and a fourth period, and
wherein the simultaneous switching unit sets the first voltage to the predetermined voltage in response to the first control signal having a first level in the third period, and sets the second voltage to the predetermined voltage in response to the second control signal having the first level in the fourth period.

4. The scan driver as claimed in claim 3, wherein:
the second control signal has a second level in the third period, and
the first control signal has the second level in the fourth period.

5. The scan driver as claimed in claim 4, wherein:
the first control signal is set to the first level after the second control signal is set to the second level in the third period, and
the second control signal is set to the first level after the first control signal is set to the second level in the fourth period.

6. The scan driver as claimed in claim 3, wherein:
each stage of the plurality of stages further includes:
a first, a second, and a third clock terminal,
first, second, and third clock signals are alternately applied to the first, the second, and the third clock terminals in each stage, and
the first, second, and third clock signals each have a cycle of 3 horizontal periods and a duty ratio of 1/3, and sequentially have the first level in the first period.

7. The scan driver as claimed in claim 6, wherein:
the sequential switching unit controls the output unit in response to the first, second, and third clock signals in the first period, and
wherein the output unit outputs a voltage of the third clock terminal as the first voltage of the scan signal in the first period.

8. The scan driver as claimed in claim 7; wherein:
a control of the simultaneous switching unit is terminated in accordance with the voltage of the third clock terminal in the first period.

9. The scan driver as claimed in claim 7, wherein:
the first, second, and third clock signals have a steady level in the second period.

10. The scan driver as claimed in claim 3, wherein:
each stage of the plurality of stages further includes:
a first, a second, and a third clock terminal,
first, second, third, fourth, fifth, and sixth clock signals each have a cycle of 6 horizontal periods and a duty ratio of 1/3, are applied to each stage, and sequentially have the first level in the first period, and the first, third, and fifth clock signals are alternately applied to the first, the second, and the third clock terminals of odd numbered stages, among the plurality of stages, and the second, fourth, and sixth clock signals are alternately applied to even numbered stages, among the plurality of stages.

11. The scan driver as claimed in claim 10, wherein:
the sequential switching unit of each odd numbered stage of the plurality of stages controls the output unit in response to the first, third, and fifth clock signals in the first period,
the sequential switching unit of each even numbered stage of the plurality of stages controls the output unit in response to the second, fourth, and sixth clock signals in the first period, and
the output unit outputs a voltage of the third clock terminal as the first voltage of the scan signal in the first period.

12. The scan driver as claimed in claim 11, wherein:
a control of the simultaneous switching unit is terminated, in accordance with the voltage of the third clock terminal in the first period.

13. The scan driver as claimed in claim 11, wherein:
the first, second, third, fourth, fifth, and sixth clock signals have a steady level.

14. A scan driver of a display device including a plurality of scan lines, the scan driver comprising:
a plurality of stages configured to transmit scan signals to the scan lines,
wherein each stage of the plurality of stages includes:
a first voltage terminal for supplying a first voltage,
a second voltage terminal for supplying a second voltage,
an input terminal for receiving a scan signal from a previous stage,
an output terminal,
a first clock terminal,
a first transistor coupled between the first voltage terminal and the output terminal, and having a gate coupled to a first junction point,
a second transistor coupled between the output terminal and the first clock terminal, and having a gate coupled to the second junction point,
a third transistor coupled between the output terminal and the second voltage terminal, and having a gate coupled to a third junction point,
a sequential switching unit coupled to the input terminal and to the first and the second junction points, and configured to control the first and the second transistors such that output units of the stages sequentially output the scan signals having the second voltage in a first period, and
a simultaneous switching unit configured to turn on the first transistor or the third transistor in a second period such that the first transistor of each stage or the second transistor of each stage is simultaneously turned on in a second period.

15. The scan driver as claimed in claim 14, wherein:
the second period includes a third period and a fourth period, and
wherein the simultaneous switching unit turns on the third transistor in the third period, and turns on the first transistor in the fourth period.

16. The scan driver as claimed in claim 14, wherein:
each stage of the plurality of stages receives a first and a second control signal,
wherein the simultaneous switching unit sets the third junction point to a gate-on voltage, in response to the first control signal having a first level in the third period, and sets the first junction point to the gate-on voltage, in response to the second control signal having the first level in the fourth period.

17. The scan driver as claimed in claim 16, wherein:
the second control signal has a second level in the third period, and the first control signal has the second level in the fourth period.

18. The scan driver as claimed in claim 16, wherein the simultaneous switching unit includes:
a fourth transistor coupled between the third junction point and the second voltage terminal, and configured to be turned on in response to the first control having the first level, and
a fifth transistor coupled between the first junction point and the second voltage terminal, and configured to be turned on in response to the second control signal having the first level.

19. The scan driver as claimed in claim 18, wherein:
the simultaneous switching unit further includes:
a sixth transistor coupled between the first voltage terminal and the first junction point, and configured to be turned on in response to the first control signal having the first level; and
a seventh transistor coupled between the first voltage terminal and the third junction point, and configured to be turned on in response to the second control signal having the first level.

20. The scan driver as claimed in claim 18, wherein:
the sequential switching unit includes:
a sixth transistor coupled between the second junction point and the first voltage terminal, and configured to be turned on in response to the first control signal having the first level.

21. The scan driver as claimed in claim 18, wherein:
each stage of the plurality of stages further includes:
a second and a third clock terminal,
the sequential switching unit includes:
a sixth transistor coupled between the first voltage terminal and the second junction point, and having a gate coupled to the first junction point,
a seventh transistor coupled between the first junction point and the second voltage terminal, and having a gate coupled to the second clock terminal, and
an eighth transistor coupled between the input terminal and the second junction point, and having a gate coupled to the third clock terminal.

22. The scan driver as claimed in claim 21, wherein:
the sequential switching unit further includes:
a ninth transistor coupled between the first voltage terminal and the first junction point, and having a gate coupled to the second junction point.

23. The scan driver as claimed in claim 21, wherein:
the sequential switching unit further includes:
a ninth transistor coupled between the first voltage terminal and the first junction point, and having a gate coupled to the input terminal.

24. The scan driver as claimed in claim 23, wherein:
a ratio of a channel width to a channel length in the fifth transistor is equal to or greater than a ratio of a channel width to a channel length in the ninth transistor.

25. The scan driver as claimed in claim 23, wherein:
the sequential switching unit further includes:
a capacitor coupled between the first voltage terminal and the first junction point.

26. The scan driver as claimed in claim 21, wherein:
first, second, and third clock signals are alternately applied to the first, the second, and the third clock terminals in each stage,
wherein the first, second, and third clock signals, each having a cycle of 3 horizontal periods and a duty ratio of 1/3, sequentially have the first level in the first period, and the second voltage corresponds to the first level of the first clock terminal, and
wherein the first, second, and third clock signals have the second level in the second period.

27. The scan driver as claimed in claim 21, wherein:
first, second, third, fourth, fifth, and sixth clock signals are applied to each stage,
the first, third, and fifth clock signals are alternately applied to the first, the second, and the third clock terminals of odd numbered stages among the stages, and the second, fourth, and sixth clock signals are alternately applied to even numbered stages among the stages,
the first, second, third, fourth, fifth, and sixth clock signals each have a cycle of 6 horizontal periods and a duty ratio of 1/3, sequentially have the first level in the first period, and the second voltage corresponds to the first level of the first clock terminal, and
the first, second, third, fourth, fifth, and sixth clock signals have the second level in the second period.

28. The scan driver as claimed in claim 21, wherein:
each stage of the plurality of stages receives a third control signal having the first level in the first period, and having the second level in the second period,
the simultaneous switching unit further includes a ninth transistor coupled between the third junction point and the first voltage terminal the first period, and configured to be turned on in response to the third control signal having the first level.

29. The scan driver as claimed in claim 21, the simultaneous switching unit further comprises:
a ninth transistor coupled between the third junction point and the first voltage terminal, and configured to be turned on in response to the first level of the first clock terminal,
wherein the first clock terminal has the first level when the scan signal has the second voltage.

30. The scan driver as claimed in claim 14, each stage further comprises:
a first capacitor coupled between the gate and a source of the second transistor; and
a second capacitor coupled between the gate and a source of the third transistor.

31. A method of driving a scan driver of a display device including a plurality of scan lines, the method comprising:
sequentially transmitting scan signals having a first voltage to the scan lines in response to a plurality of clock signals, each having the first level and the second level in turn;
simultaneously transmitting the scan signals having the first voltage to the scan lines in response to a first control signal having the first level, while maintaining the clock signals at the second level; and
simultaneously transmitting the scan signals having a second voltage to the scan lines in response to a second control signal having the first level, while maintaining the clock signals at the second level.

32. The method as claimed in claim 31, wherein:
the simultaneous transmission of the scan signals having the first voltage includes setting the first control signal to the first level after setting the second control signal to the second level.

33. The method as claimed in claim 31, wherein:
the simultaneous transmission of the scan signals having the second voltage includes setting the second control signal to the first level, after setting the first control signal to the second level.

34. The method as claimed in claim 31, wherein:
the sequential transmission of the scan signals having the first voltage includes receiving a third control signal having the first level, wherein the simultaneous transmission of the scan signals having the first voltage includes receiving the third control signal having the second level, and wherein the simultaneous transmission of the scan signals having the second voltage includes receiving the third control signal having the second level.
